(19) United States
(12) Patent Application Publication
(10) Pub. No.: US 2016/0277550 A1
(43) Pub. Date: Sep. 22, 2016

(54) INFORMATION PROCESSING METHOD AND ELECTRONIC DEVICE

(71) Applicants: Beijing Lenovo Software Ltd., Beijing (CN); Lenovo (Beijing) Limited, Beijing (CN)

(72) Inventors: Yong Tan, Beijing (CN); Jianguo Xu, Beijing (CN); Qiuru Bao, Beijing (CN)

(21) Appl. No.: 14/747,556

(22) Filed: Jun. 23, 2015

(30) Foreign Application Priority Data
Mar. 16, 2015 (CN) 201510114234.3

(51) Int. Cl. H04M 1/02

(52) U.S. Cl. CPC H04M 1/0225

(57) ABSTRACT

The present disclosure discloses an information processing method applied to an electronic device having a movable portion and a main body. The method includes: detecting an operation when a first relative positional relationship is formed between the movable portion and the main body, and the electronic device is in a first operation mode corresponding to the first relative positional relationship; and triggering the movable portion to rotate and form a second relative positional relationship with the main body to change the electronic device to a second operation mode, upon determining that the operation triggers to invoke a first functional module of the movable portion and a second functional module of the main body.

### PRIORITY APPLICATION

The application claims the benefit of priority under 35 U.S.C. 119 to Chinese Application No. 201510114234.3, filed on 16 Mar. 2015; which application is incorporated herein by reference in its entirety.

### TECHNICAL FIELD

The present disclosure relates to information processing technology, and in particular, to an information processing method and an electronic device.

### BACKGROUND

In addition to voice communication function, electronic devices such as smart phones or the like also provide a variety of operation modes to meet users' requirements in different usage scenarios. Currently, there is no effective solution in the related art to enable an electronic device to rapidly switch back to a voice communication operation mode from a variety of operation modes for convenience of a user's voice communication.

### SUMMARY

In one aspect, the embodiments of the present disclosure provide an information processing method applied to an electronic device having a movable portion and a main body. The movable portion has a first functional module, and the main body has a second functional module. The method includes: detecting an operation if a first relative positional relationship is formed between the movable portion and the main body, the electronic device is in a first operation mode corresponding to the first relative positional relationship; and triggering the movable portion to rotate and form a second relative positional relationship with the main body to change the electronic device to a second operation mode, upon determining that the operation triggers to invoke the first functional module and the second functional module.

In an embodiment, a portion of the first functional module is exposed on a first end surface of the movable portion, and a portion of the second functional module is exposed on a first end surface of the main body. When the movable portion and the main body form the second relative positional relationship, an orientation of the first end surface of the movable portion is same as that of the first end surface of the main body.

In an embodiment, the method further includes: analyzing the operation to obtain operating parameters of the operation; determining whether the operating parameters of the operation match with preset operating parameters; and determining that the operation triggers to invoke the first functional module and the second functional module, if the obtained operating parameters of the operation match with preset operating parameters.

In an embodiment, the method further includes: triggering the movable portion to rotate relative to the main body and form an angle larger than 0 degree relative to the main body when the electronic device is in the first operation mode; and triggering the movable portion to rotate relative to the main body and form an angle equal to 0 degree relative to the main body when the electronic device is in the second operation mode.

In another aspect, the embodiments of the present disclosure provide an electronic device having a movable portion and a main body. The movable portion has a first functional module, and the main body has a second functional module and processor. The processor is configured to: detect an operation, if a first relative positional relationship is formed between the movable portion and the main body, the electronic device is in a first operation mode corresponding to the first relative positional relationship; trigger the movable portion to rotate and form a second relative positional relationship with the main body to change the electronic device to a second operation mode upon determining that the operation triggers to invoke the first functional module and the second functional module.

In an embodiment, a portion of the first functional module is exposed on a first end surface of the movable portion, and a portion of the second module is exposed on a first end surface of the main body. When the movable portion and the main body form the second relative positional relationship, an orientation of the first end surface of the movable portion is same as that of the first end surface of the main body.

In an embodiment, the main body and/or the movable portion has a first sensor module. The first sensor module is configured to output first sensing data representing a relative positional relationship between the movable portion and the main body. The processor is further configured to analyze the sensing data output by the sensor module, to obtain the relative positional relationship between the movable portion and the main body.

In an embodiment, the main body and/or the movable portion has a second sensor module. The second sensor module is configured to output second sensing data representing operating features of the operation upon the operation is detected. The processor is further configured to: analyze the second sensing data output by the second sensor module to obtain the operating parameters of the operation, and determine that the operation triggers to invoke the first functional module and the second functional module if the operating parameters of the operation match with preset operating parameters.

In an embodiment, the main body has a movable connecting member and a driving member. The movable portion is connected to the main body through the movable connecting member, the driving member is connected to the processor and the movable connecting member, the driving member and the movable connecting member form a transmission structure. The processor is further configured to trigger the driving member to output power and transmit the output power to the movable portion through the movable connecting member, so as to drive the movable portion to rotate relative to the main body and form the second relative positional relationship with the main body.

In an embodiment, the processor is further configured to trigger the movable portion to rotate relative to the main body and form an angle larger than 0 degree relative to the main body when the electronic device is in the first operation mode.

In an embodiment, the processor is further configured to trigger the movable portion to rotate relative to the main body and form an angle equal to 0 degree relative to the main body when the electronic device is in the second operation mode.

In an embodiment, the first functional module is an audio output module, and the second functional module is an audio input module.

In another aspect, the embodiments of the present disclosure provide a computer readable storage medium having stored therein computer program instructions which, when being executed by an electronic device having a movable portion with a first functional module and a main body with a second functional module, cause the electronic device to perform:

detecting an operation if a first relative positional relationship is formed between the movable portion and the main body, and the electronic device is in a first operation mode corresponding to the first relative positional relationship; and

triggering the movable portion to rotate and form a second relative positional relationship with the main body to change the electronic device to a second operation mode, upon determining that the operation triggers to invoke a first functional module of the movable portion and a second functional module of the main body.

### BRIEF DESCRIPTION OF THE DRAWINGS

FIG. 1 is a first structural diagram of an electronic device according to an embodiment of the present disclosure;

FIG. 2 is a second structural diagram of an electronic device according to an embodiment of the present disclosure;

FIG. 3 is a third structural diagram of an electronic device according to an embodiment of the present disclosure;

FIG. 4 is a fourth structural diagram of an electronic device according to an embodiment of the present disclosure;

FIG. 5 is a flowchart of an information processing method according to an embodiment of the present disclosure;

FIG. 6 is a fifth diagram of using an electronic device according to an embodiment of the present disclosure;

FIG. 7 is a sixth diagram of using an electronic device according to an embodiment of the present disclosure;

FIG. 8 is a seventh structural diagram of an electronic device according to an embodiment of the present disclosure;

FIG. 9 is an eighth structural diagram of an electronic device according to an embodiment of the present disclosure;

FIG. 10 is a ninth structural diagram of an electronic device according to an embodiment of the present disclosure; and

FIG. 11 is a tenth structural diagram of an electronic device according to an embodiment of the present disclosure.

### DETAILED DESCRIPTION

The present disclosure will be further described in detail below in conjunction with accompanying drawings and specific embodiments.

### First Embodiment

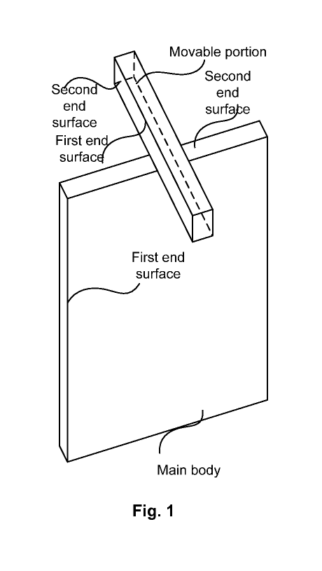

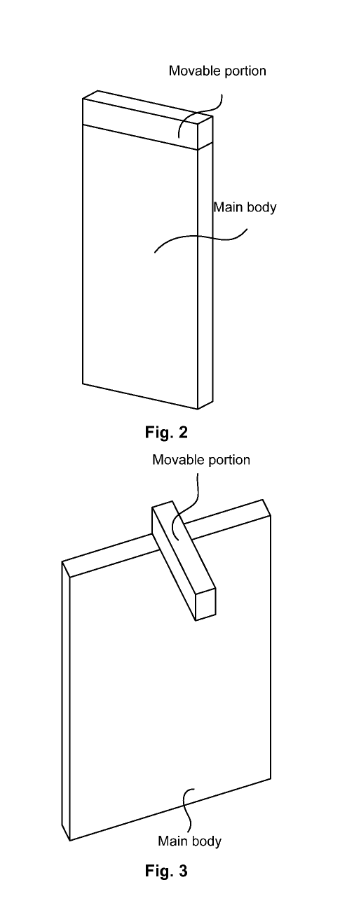

In the present embodiment, an information processing method applied in an electronic device is described. As shown in FIG. 1, the electronic device comprises a movable portion and a main body. The movable portion has a second end surface, which is of the same shape and has the same area as a second end surface of the main body. Therefore, when the movable portion and the main body are in a second relative positional relationship, the movable portion and the main body may be of a shape of a standard cuboid as shown in FIG. 2.

In an example, as shown in FIG. 3, the second end surface of the movable portion may have an area smaller than that of the second end surface of the main body.

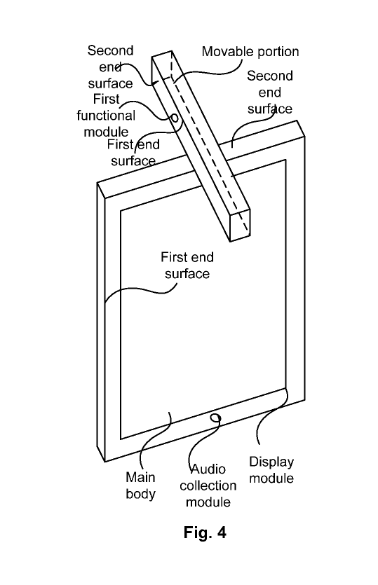

As shown in FIG. 4, the movable portion of the electronic device may have a first functional module arranged therein (which is an audio output module as an example in this embodiment, or may also be an image collection module in practical applications). A part of the first functional module is exposed on a first end surface of the movable portion. The main body has a second functional module arranged therein (which may be an audio input module and a display module as an example in FIG. 4). A part of the second functional module is exposed on a first end surface of the main body.

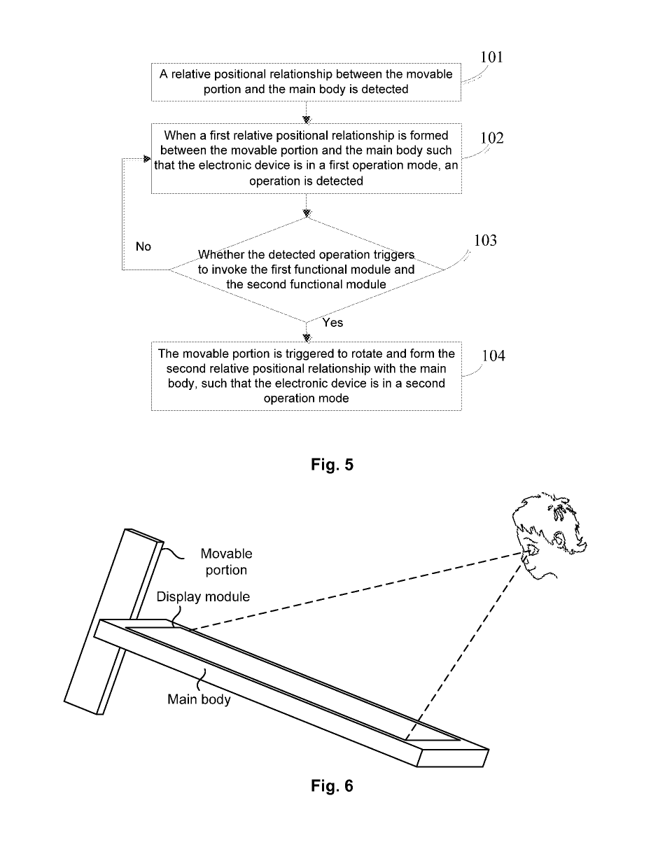

As shown in FIG. 5, the information processing method according to the present embodiment comprises the following steps.

In step 101, a relative positional relationship between the movable portion and the main body is detected.

The movable portion and/or the main body may have a sensor arranged therein, and sensing data collected by the sensor module arranged in the movable portion and/or the main body may be parsed to obtain the relative positional relationship between the main body and the movable portion.

The sensor module may be arranged in the following manners.

In the first manner, the movable portion and the main body may each have a sensor module arranged therein, which may be a gyroscope here. The gyroscope arranged in the main body may collect data representing a position of the main body, and the gyroscope of the movable portion may collect data representing a position of the movable portion.

In the second manner, only the movable portion has a sensor module arranged therein, which may be a proximity sensor here. The proximity sensor of the movable portion may collect data representing a positional relationship between the movable portion and the main body.

In the third manner, only the main body has a sensor module arranged therein, which may be a proximity sensor here. The proximity sensor of the main body may collect data representing a positional relationship between the movable portion and the main body.

When the sensing data indicates that an angle of the movable portion relative to the main body is equal to 0 degree, and the orientation of the collection module arranged on the first end surface of the movable portion is same as that of the display module arranged on the first end surface of the main body, it is determined that the movable portion and the main body are in the second relative positional relationship.

In step 102, when a first relative positional relationship is formed between the movable portion and the main body such that the electronic device is in a first operation mode, an operation is detected.

The positional relationships between the main body and the movable portion comprise the first relative positional relationship and the second relative positional relationship.

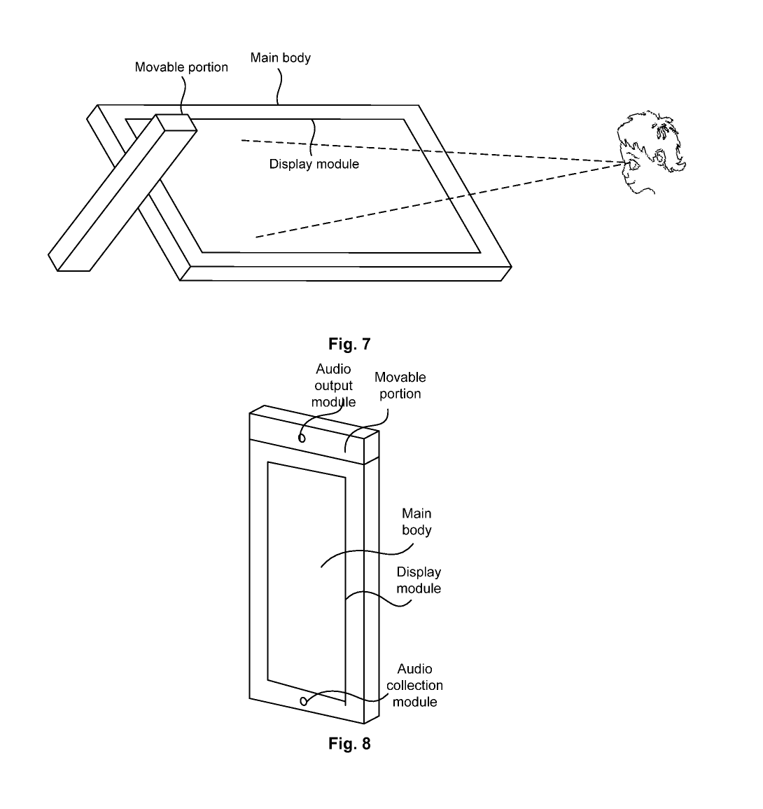

The first relative positional relationship is a positional relationship in which there is a certain angle of the main body relative to the movable portion, and corresponds to the first operation mode. The first operation mode may be a projection mode as shown in FIGS. 6 and 7, in which the movable portion and the main body are in the first relative positional relationship, so that the angle of the display module in the main body relative to the movable portion is suitable for view.

The second relative positional relationship is a positional relationship in which an angle of the main body relative to the movable portion is equal to 0 degree, and the orientation of the first end surface of the movable portion is same as that of the first end surface of the main body, so that the orientation of the first functional module is same as that of the second functional module. As an example, the second relative positional relationship may correspond to an answer mode (corresponding to a second operation mode), for convenience of answering the phone by a user with the main body of the electronic device in hand.

In step 103, it is judged whether the detected operation triggers to invoke the first functional module and the second functional module, and if so, step 104 is performed; otherwise, the process returns to step 102.

The first functional module is an audio output module and the second functional module is an audio input module here. Therefore, when the detected operation triggers to invoke the first functional module and the second functional module, it means that the operation is to trigger voice communication. The operation may be an operation implemented by a user here. For example, a user implements a particular operation on a display module (which supports a touch operation) of the electronic device to invoke the first functional module and the second functional module to implement a voice call operation. Alternatively, when the electronic device receives an incoming call, it is also considered as receiving an operation to invoke the first functional module and the second functional module.

In step 104, when it is determined that the operation triggers to invoke the first functional module and the second functional module, the movable portion is triggered to rotate and form the second relative positional relationship with the main body, so that the electronic device is in the second operation mode.

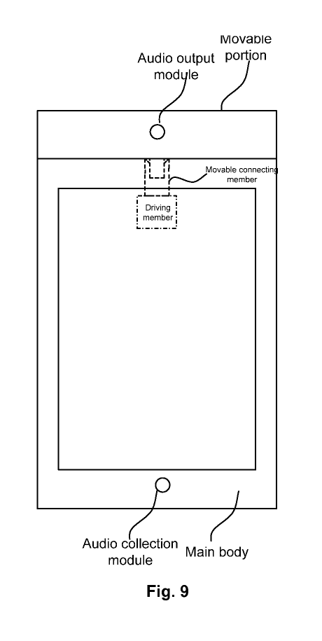

As shown in FIG. 9, the main body may be connected to the movable portion through a movable connecting member. When it needs to trigger the movable portion to rotate, a driving member (such as a motor) connected to the movable connecting member drives the movable connecting member to rotate so as to change the relative positional relationship between the movable portion and the main body. When the movable portion and the main body portion are in the second relative positional relationship, the orientation of the first end surface of the movable portion is same as that of the first end surface of the main body.

In a practical application scenario, when the main body and the movable portion of the electronic device form the first relative positional relationship, the electronic device is in a projection mode (corresponding to the first operation mode). When a voice call is received by the electronic device, it is determined that it needs to invoke the audio output module (corresponding to the first functional module) and the audio input module (corresponding to the second functional module) in response to the voice call. Therefore, the movable portion is triggered to rotate and form the second relative positional relationship with the main body, so that the electronic device is in the second operation mode, i.e., an operation mode in which phone answering is supported, for convenience of answering the phone by a user with the main body of the electronic device in hand.

In the embodiment of the present disclosure, the movable portion and the main body may form different relative positional relationships, which correspond to different operation modes of the electronic device. This enables the electronic device to operate in a variety of operation modes, thereby meeting users' requirements in different usage scenarios. In addition, when the electronic device is required to be used in an answer operation mode (corresponding to the second operation mode, for example, voice communication operation mode), fast switching between the operation modes (from the first operation mode to the second operation mode) can be achieved by changing a relative positional relationship between the movable portion and the main body, which meet requirements for responding to users' voice communication in time.

### Second Embodiment

An electronic device is described in the present embodiment. As shown in FIG. 1, the electronic device comprises a movable portion and a main body. The movable portion has a second end surface, which is of the same shape and has the same area as a second end surface of the main body. Therefore, when the movable portion and the main body are in a second relative positional relationship, the movable portion and the main body may be of a shape of a standard cuboid as shown in FIG. 2.

In an example, as shown in FIG. 3, the second end surface of the movable portion may have an area smaller than that of the second end surface of the main body.

As shown in FIG. 4, the movable portion of the electronic device may have a first functional module arranged therein (which is an audio output module as an example in this embodiment, or may also be an image collection module in practical applications). A part of the first functional module is exposed on a first end surface of the movable portion. The main body has a second functional module arranged therein (which may be an audio input module and a display module as an example in FIG. 4). A part of the second functional module is exposed on a first end surface of the main body.

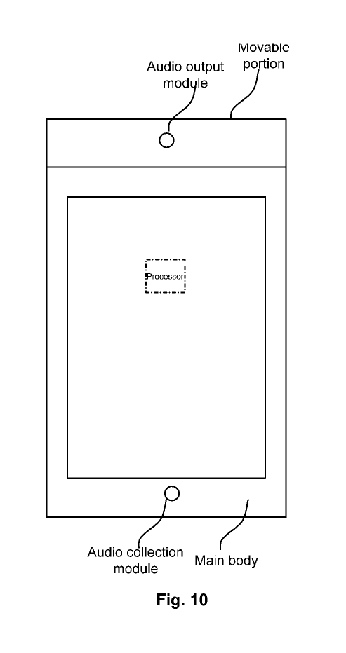

As shown in FIG. 10, the main body further has a processor arranged therein, wherein the processor is configured to detect an operation when a first relative positional relationship is formed between the movable portion and the main body such that the electronic device is in a first operation mode.

The processor is further configured to trigger the movable portion to rotate and form a second relative positional relationship with the main body such that the electronic device is in a second operation mode upon determining that the operation triggers to invoke the first functional module and the second functional module.

When the movable portion and the main body are in the second relative positional relationship, the orientation of the first end surface of the movable portion is same as that of the first end surface of the main body.

As an example, the main body and/or the movable portion may have a first sensor module (corresponding to a sensor) arranged therein.

The first sensor module is configured to output first sensing data representing a relative positional relationship between the movable portion and the main body.

The processor is further configured to parse the sensing data output by the sensor module, to obtain the relative positional relationship between the movable portion and the main body.

The first sensor module may be arranged in the following manners.

In the first manner, the movable portion and the main body may each have a first sensor module arranged therein, which may be a gyroscope here. The gyroscope arranged in the main body may collect data representing a position of the main body, and the gyroscope of the movable portion may collect data representing a position of the movable portion.

In the second manner, only the movable portion has a first sensor module arranged therein, which may be a proximity sensor here. The proximity sensor of the movable portion may collect data representing a positional relationship between the movable portion and the main body.

In the third manner, only the main body has a first sensor module arranged therein, which may be a proximity sensor here. The proximity sensor of the main body may collect data representing a positional relationship between the movable portion and the main body.

When the sensing data indicates that an angle of the movable portion relative to the main body is equal to 0 degree, and the orientation of the collection module arranged on the first end surface of the movable portion is same as that of the display module arranged on the first end surface of the main body, it is determined that the movable portion and the main body are in the second relative positional relationship.

The positional relationships between the main body and the movable portion comprise the first relative positional relationship and the second relative positional relationship.

The first relative positional relationship is a positional relationship in which there is a certain angle of the main body relative to the movable portion, and corresponds to the first operation mode. The first operation mode may be a projection mode as shown in FIGS. 6 and 7, in which the movable portion and the main body are in the first relative positional relationship, so that the angle of the display module in the main body relative to the movable portion is suitable for view.

The second relative positional relationship is a positional relationship in which an angle of the main body relative to the movable portion is equal to 0 degree, and the orientation of the first end surface of the movable portion is same as that of the first end surface of the main body, so that the orientation of the first functional module is same as that of the second functional module. As an example, the second relative positional relationship may correspond to an answer mode (corresponding to a second operation mode), for convenience of answering the phone by a user with the main body of the electronic device in hand.

The first functional module is an audio output module and the second functional module is an audio input module here. Therefore, when the detected operation triggers to invoke the first functional module and the second functional module, it means that the operation is to trigger voice communication. The operation may be an operation implemented by a user here. For example, a user implements a particular operation on a display module (which supports a touch operation) of the electronic device to invoke the first functional module and the second functional module to implement a voice call operation. Alternatively, when the electronic device receives an incoming call, it is also considered as receiving an operation to invoke the first functional module and the second functional module.

As another example, the main body and/or the movable portion may have a second sensor module (for example, a gyroscope) arranged therein;

The second sensor module is configured to output second sensing data representing operating features of the operation when the electronic device is operated.

The processor is further configured to parse the second sensing data output by the second sensor module to obtain operating parameters of the operation, and judge that the operation triggers to invoke the first functional module and the second functional module when the operating parameters of the operation match with preset operating parameters. For example, when a particular operation is implemented on the handheld electronic device (for example, the electronic device is swung along a certain trajectory), if operating parameters corresponding to the trajectory of the operation match with operating parameters of a preset trajectory, it is determined that the operation implemented by a user on the handheld electronic device is to invoke the first functional module and the second functional module.

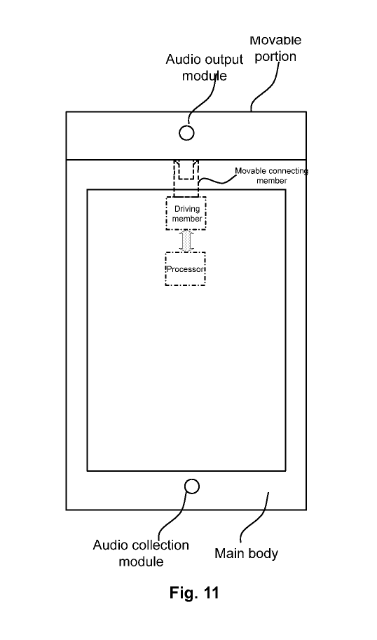

As shown in FIG. 11, the main body further has a movable connecting member and a driving member arranged therein, wherein the movable portion is connected to the main body through the movable connecting member, the driving member is connected to the processor and the movable connecting member, respectively, and the driving member and the movable connecting member form a transmission structure.

The processor is further configured to trigger the driving member to output power, and transmit the output power to the movable portion through the movable connecting member, so as to drive the movable portion to rotate relative to the main body and form a second relative positional relationship with the main body.

The main body may be connected to the movable portion through the movable connecting member. When it needs to trigger the movable portion to rotate, the driving member (such as a motor) connected to the movable connecting member drives the movable connecting member to rotate so as to change the relative positional relationship between the movable portion and the main body. When the movable portion and the main body portion are in the second relative positional relationship, the orientation of the first end surface of the movable portion is same as that of the first end surface of the main body. The processor is configured to trigger the movable portion to rotate relative to the main body and form an angle larger than 0 degree relative to the main body by controlling the driving member to output power, so that the electronic device is in the first operation mode; and the processor is configured to trigger the movable portion to rotate relative to the main body and form an angle equal to 0 degree relative to the main body by controlling the driving member to output power, so that the electronic device is in the second operation mode, and the orientation of the collection module arranged on the first end surface of the movable portion is same as that of the display module arranged on the first end surface of the main body.

In a practical application scenario, when the main body and the movable portion of the electronic device are in the first relative positional relationship, the electronic device is in a projection mode (corresponding to the first operation mode). When a voice call is received by the electronic device, it is determined that it needs to invoke the audio output module (corresponding to the first functional module) and the audio input module (corresponding to the second functional module) in response to the voice call. Therefore, the movable portion is triggered to rotate and form the second relative positional relationship with the main body, so that the electronic device is in the second operation mode, i.e., an operation mode in which phone answering is supported, for convenience of answering the phone by a user with the main body of the electronic device in hand.

As shown in FIG. 5, the processing procedure of the processor comprises the following steps based on the above structure.

In step 101, a relative positional relationship between the movable portion and the main body is detected.

The movable portion and/or the main body may have a sensor arranged therein, and sensing data collected by the sensor module arranged in the movable portion and/or the main body may be parsed to obtain the relative positional relationship between the main body and the movable portion.

The sensor module may be arranged in the following manners.

In the first manner, the movable portion and the main body may each have a sensor module arranged therein, which may be a gyroscope here. The gyroscope arranged in the main body may collect data representing a position of the main body, and the gyroscope of the movable portion may collect data representing a position of the movable portion.

In the second manner, only the movable portion has a sensor module arranged therein, which may be a proximity sensor here. The proximity sensor of the movable portion may collect data representing a positional relationship between the movable portion and the main body.

In the third manner, only the main body has a sensor module arranged therein, which may be a proximity sensor here. The proximity sensor of the main body may collect data representing a positional relationship between the movable portion and the main body.

When the sensing data indicates that an angle of the movable portion relative to the main body is equal to 0 degree, and the collection module arranged on the first end surface of the movable portion is orientated in the same direction as the display module arranged on the first end surface of the main body, it is determined that the movable portion and the main body are in the second relative positional relationship.

In step 102, when a first relative positional relationship is formed between the movable portion and the main body such that the electronic device is in a first operation mode, an operation is detected.

The positional relationship between the main body and the movable portion comprises the first relative positional relationship and the second relative positional relationship.

The first relative positional relationship is a positional relationship in which there is a certain angle of the main body relative to the movable portion, and corresponds to the first operation mode. The first operation mode may be a projection mode as shown in FIGS. 6 and 7, in which the movable portion and the main body are in the first relative positional relationship, so that the angle of the display module in the main body relative to the movable portion is suitable for view.

The second relative positional relationship is a positional relationship in which an angle of the main body relative to the movable portion is equal to 0 degree, and the orientation of the first end surface of the movable portion is same as that of the first end surface of the main body, so that the orientation of the first functional module is same as that of the second functional module. As an example, the second relative positional relationship may correspond to an answer mode (corresponding to a second operation mode), for convenience of answering the phone by a user with the main body of the electronic device in hand.

In step 103, it is judged whether the detected operation triggers to invoke the first functional module and the second functional module, and if so, step 104 is performed; otherwise, the process returns to step 102.

The first functional module is an audio output module and the second functional module is an audio input module here. Therefore, when the detected operation triggers to invoke the first functional module and the second functional module, it means that the operation is to trigger voice communication. The operation may be an operation implemented by a user here. For example, a user implements a particular operation on a display module (which supports a touch operation) of the electronic device to invoke the first functional module and the second functional module to implement a voice call operation. Alternatively, when the electronic device receives an incoming call, it is also considered as receiving an operation to invoke the first functional module and the second functional module.

In step 104, when it is determined that the operation triggers to invoke the first functional module and the second functional module, the movable portion is triggered to rotate and form the second relative positional relationship with the main body, so that the electronic device is in the second operation mode.

One ordinarily skilled in the art can understand that all or a part of steps for implementing the above method embodiments may be implemented by programs instructing related hardware. The programs above may be stored in a computer readable storage medium. When the programs are executed, the steps of the above method embodiments are implemented. The storage medium above may be a medium which can store application codes, such as a mobile storage device, a Read-Only Memory (ROM), a Random Access Memory (RAM), a disk, or a disc etc.

Alternatively, the integrated unit according to the present disclosure may also be stored in a computer readable storage medium when it is implemented in a form of software functional module and is sold or used as an independent product. Based on this understanding, the substance of the technical solutions according to the embodiments of the present disclosure or portions of the technical solutions which contribute to the related art may be embodied in a form of software product. The computer software product is stored in a storage medium, including a number of instructions to enable a computer device (which may be a personal computer, a server, or a network device or the like) to perform all or a part of the methods according to various embodiments of the present disclosure. The storage medium described above may be a medium which can store application codes, such as a mobile storage device, a Read-Only Memory (ROM), a Random Access Memory (RAM), a disk, or a disc or the like.

The above description is merely specific embodiments of the present disclosure, and the scope of the present disclosure is not limited thereto. Changes or substitutions, which can be obviously envisaged by those skilled persons in the art, should be included in the scope of the present disclosure without departing the scope defined by the appended claims. Therefore, the protection scope of the present disclosure is defined by the claims.

I/We claim:

1. An information processing method applied to an electronic device having a movable portion and a main body, the movable portion comprising a first functional module and the main body comprising a second functional module, the method comprising:
detecting an operation if a first relative positional relationship is formed between the movable portion and the main body, and the electronic device is in a first operation mode corresponding to the first relative positional relationship; and
triggering the movable portion to rotate and form a second relative positional relationship with the main body to change the electronic device to a second operation mode, upon determining that the operation triggers to invoke a first functional module of the movable portion and a second functional module of the main body.

2. The method according to claim 1, wherein a portion of the first functional module is exposed on a first end surface of the movable portion, a portion of the second functional module is exposed on a first end surface of the main body;
when the movable portion and the main body form the second relative positional relationship, an orientation of the first end surface of the movable portion is same as that of the first end surface of the main body.

3. The method according to claim 1, further comprising:
analyzing the operation to obtain operating parameters of the operation;
determining whether the operating parameters of the operation match with preset operating parameters; and
determining that the operation triggers to invoke the first functional module and the second functional module, if the obtained operating parameters of the operation match with preset operating parameters.

4. The method according to claim 1, further comprising:
triggering the movable portion to rotate relative to the main body and form an angle larger than 0 degree relative to the main body when the electronic device is in the first operation mode; and
triggering the movable portion to rotate relative to the main body and form an angle equal to 0 degree relative to the main body when the electronic device is in the second operation mode.

5. The method according to claim 1, wherein
the first functional module is an audio output module, and the second functional module is an audio input module.

6. An electronic device, comprising:
a movable portion comprising a first functional module; and
a main body comprising a second functional module and a processor, the processor is configured to:
detect an operation, if a first relative positional relationship is formed between the movable portion and the main body, and the electronic device is in a first operation mode corresponding to the first relative positional relationship;
trigger the movable portion to rotate and form a second relative positional relationship with the main body to change the electronic device to a second operation mode, upon determining that the operation triggers to invoke the first functional module and the second functional module.

7. The electronic device according to claim 6, wherein a portion of the first functional module is exposed on a first end surface of the movable portion, a portion of the second module is exposed on a first end surface of the main body;
when the movable portion and the main body form the second relative positional relationship, an orientation of the first end surface of the movable portion is same as that of the first end surface of the main body.

8. The electronic device according to claim 7, wherein the main body and/or the movable portion further comprising a first sensor module,
the first sensor module is configured to output first sensing data representing a relative positional relationship between the movable portion and the main body; and
wherein the processor is further configured to analyze the sensing data output by the sensor module, to obtain the relative positional relationship between the movable portion and the main body.

9. The electronic device according to claim 7, wherein the main body and/or the movable portion further comprising a second sensor module,
the second sensor module is configured to output second sensing data representing operating features of the operation upon the operation is detected; and
wherein the processor is further configured to:
analyze the second sensing data output by the second sensor module to obtain the operating parameters of the operation; and
determine that the operation triggers to invoke the first functional module and the second functional module, if the operating parameters of the operation match with preset operating parameters.

10. The electronic device according to claim 7, wherein the main body further comprises a movable connecting member and a driving member; the movable portion is connected to the main body through the movable connecting member, the driving member is connected to the processor and the movable connecting member; the driving member and the movable connecting member form a transmission structure; and
the processor is further configured to trigger the driving member to output power and transmit the output power to the movable portion through the movable connecting member, so as to drive the movable portion to rotate relative to the main body and form the second relative positional relationship with the main body.

11. The electronic device according to claim 7, wherein
the processor is further configured to trigger the movable portion to rotate relative to the main body and form an angle larger than 0 degree relative to the main body when the electronic device is in the first operation mode.

12. The electronic device according to claim 7, wherein
the processor is further configured to trigger the movable portion to rotate relative to the main body and form an angle equal to 0 degree relative to the main body when the electronic device is in the second operation mode.

13. The electronic device according to claim 7, wherein
the first functional module is an audio output module, and the second functional module is an audio input module.

14. A computer readable storage medium having stored therein computer program instructions which, when being executed by an electronic device having a movable portion with a first functional module, and a main body with a second functional module, cause the electronic device to perform:
detecting an operation if a first relative positional relationship is formed between the movable portion and the main body, and the electronic device is in a first operation mode corresponding to the first relative positional relationship; and
triggering the movable portion to rotate and form a second relative positional relationship with the main body to change the electronic device to a second operation mode, upon determining that the operation triggers to invoke a first functional module of the movable portion and a second functional module of the main body.
